(19) United States
(12) Patent Application Publication
(10) Pub. No.: US 2008/0284304 A1
(43) Pub. Date: Nov. 20, 2008

(54) SPARK PLUG FOR INTERNAL COMBUSTION ENGINE

(75) Inventors: Kiyohiko Watanabe, Okazaki-shi (JP); Shinichi Okabe, Aichi-ken (JP); Kimitaka Saitoh, Nagoya (JP); Masamichi Shibata, Toyota-shi (JP); Ken Hanashi, Handa-shi (JP); Kengo Nakao, Kariya-shi (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/120,910

(22) Filed: May 15, 2008

(30) Foreign Application Priority Data
May 15, 2007 (JP) 2007-129258

(51) Int. Cl. H01T 13/20

(52) U.S. Cl. 313/141

(57) ABSTRACT

There is provided a spark plug that includes a center electrode, an insulator, a housing, a ground electrode, an auxiliary ground electrode, and a projected portion in the housing. The housing has a though-hole which is formed in the housing along the longitudinal axis of the center electrode and has an opening of the through-hole at the first housing end. The ground electrode has a first end facing the end of the center electrode to form a first discharge gap. The auxiliary ground electrode has a first end facing an outer peripheral surface of the first end of the insulator to form a second discharge gap. The projected portion is formed in a hollow portion of the through-hole and is projected from an inner peripheral surface of the hollow portion of the housing.

### CROSS REFERENCE TO RELATED APPLICATION

The present application relates to and incorporated by reference Japanese Patent Application No. 2007-129258 filed on May 15, 2007.

### BACKGROUND OF THE INVENTION

1. The Field of the Invention

The present invention relates to spark plugs for use in internal combustion engines of automotive vehicles and cogeneration systems. More particularly, the present invention relates to a spark plug for igniting fuel in an internal combustion engine.

2. Description of the Related Art

There is known a spark plug for an internal combustion engine for igniting air-fuel mixture which is installed within a combustion chamber of the engine.

The spark plug includes a cylindrically shaped housing, a cylindrically shaped insulator attached to the housing and having a tip end, a center electrode inserted through the insulator and projecting from the tip end of the insulator, and a ground electrode attached to the housing and facing the center electrode. The center electrode and the ground electrode are arranged to interpose a spark gap therebetween. To operate the spark plug, the spark plug is inserted into a combustion chamber of the engine. In the combustion chamber of the engine, the air-fuel mixture is injected. The center electrode and the ground electrode are arranged to be located so as to be exposed to the air-fuel mixture in the combustion chamber. When a high voltage of approximately 10 kV to 35 kV is applied from an ignition system between the center electrode and the ground electrode of the spark plug, spark discharge occurs in the spark gap interposed between the center electrode and the ground electrode of the spark plug so that the air-fuel mixture in the combustion chamber is ignited. The ignition system includes an ignition coil, electric power supply, and a switch. The ignition coil connects to the spark plug, and has an internal capacitor. The switch is inserted between the ignition coil and the spark plug. The electric power supply supplies an electric power to the ignition coil to accumulate electric charge or electrical energy in the ignition coil. When the switch is turned on, the electrical energy accumulated in the ignition coil is discharged to the spark plug to ignite the air-fuel mixture in the combustion chamber.

The spark discharge is categorized into capacitive discharge and inductive discharge. According to the above described discharge, the inductive discharge occurs after the capacitive discharge. The capacitive discharge is an insulation breakdown phenomena, and air is subjected to insulation breakdown by the capacitive discharge. The capacitive discharge is generated when the switch is turned on to start of supply of the electric charge accumulated in the internal capacitor of the ignition coil to the spark plug. The inductive discharge is induced by electromagnetic induction energy which is discharged from the ignition coil to the spark plug.

Hence, there is need to cause the capacitive discharge in the spark gap to ignite the spark discharge. In general, the breakdown voltage to be applied to the spark gap to cause the capacitive discharge in the spark gap is much higher than breakdown voltage in the inductive discharge, and the breakdown voltage in the capacitive discharge is referred as the breakdown voltage at the spark gap. Thus, if the breakdown voltage in the capacitive discharge that is induced by the electric charge accumulated in the internal capacitor of the ignition coil could be lowered, a required electric voltage which is required to be applied between the center electrode and the ground electrode of the spark plug to induce the spark discharge can also be lowered so that ignitability and ignition performance of the spark plug would be improved.

One of methods for reducing the required voltage is given by shortening the spark gap. However, a short spark gap may cause a misfire because flame kernel formed in the inductive discharge is liable to be brought into contact with the center electrode or the ground electrode and energy of the flame kernel is liable to be absorbed by the center electrode or the ground electrode during growth of the flame kernel. Accordingly, the growth of the flame kernel is hindered and ignitability and ignition performance of the spark plug is lessened.

Yoshinaga et al. disclose in Japanese Patent Application Laid-Open No. 10-172715 a spark plug which is configured to move the position at which inductive discharge occurs from one portion at which the inductive discharge is ignited to another portion made of a material having a larger electrical resistance than that of the former so that flame kernel formed at spark gap can be grown and breakdown voltage can be reduced so as to improve ignitability and ignition performance of the spark plug.

Specifically, the spark plug of Yoshinaga et al. includes a cylindrical shaped insulator having a central through-hole formed therein, a elongated center electrode having an tip end and being held in the central through-hole of the insulator such that the tip end of the center electrode projects from an end portion of the insulator, a substantially cylindrical shaped housing having two end surfaces and holding the insulator such that an end of the insulator at which the center electrode is disposed projects from one of the end surfaces, and a ground electrode that has two ends and is disposed such that one of the ends of the ground electrode is joined to one end surface of the housing and the another end of the ground electrode is positioned to face the tip end of the center electrode along a longitudinal axis of the center electrode with a gap. Further, the center electrode has a large diameter portion and a small diameter portion made of the material having the larger electrical resistance than that of the former. For example, the small diameter portion is made of semi-conductive ceramics such as TiO, Al₂O₃, and the like. The small diameter portion is coaxial with the large diameter portion and is formed at the tip end of the center electrode. Hence, in the spark plug of Yoshinaga et al., the inductive discharge is ignited at the small diameter portion of the center electrode when a predetermined breakdown voltage is applied at the spark gap formed between the center electrode and the ground electrode. At this initial stage of spark discharge, due to the small diameter of the center electrode, rapid cooling of the flame kernel formed at the spark gap is prevented from occurring, and thus the breakdown voltage can be reduced. After the initial stage of spark discharge, inductive discharge occurs between the large diameter portion of the center electrode and the ground electrode. Therefore, ignitability and ignition performance of the spark plug can be improved in the spark plug of Yoshinaga et al.

However, in the spark plug of Yoshinaga et al., consumption of the center electrode is accelerated because the small diameter portion at which the inductive discharge is ignited is made of the semi-conductive ceramics. As a result of this, wear of the center electrode is increased so that the lifetime of the spark plug is reduced. Further, the spark plug of Yoshinaga et al. has a cost disadvantage because the center electrode is not a cylindrical shape, but has the large diameter portion and the small diameter portion which are made of different materials.

Further, Mogi et al. disclose in Japanese Patent Application Laid-Open No. 9-320735 an ignition plug which is configured to realize stable spark discharge by lowering the breakdown voltage to be required for spark discharge.

The ignition plug of Mogi et al., has a center electrode and a ground electrode opposite to each other via a specific gap. Spark discharge is generated by applying high electric voltage between the center electrode and the ground electrode. The center electrode includes a body portion having an end surface and a semiconductor layer provided on the end surface of the body portion such that the ground electrode faces to the semiconductor layer via the specific gap. The body portion of the center electrode is made of metal, for example, nickel, platinum, gold, or iridium. The semiconductor layer of the center electrode is mode of, for example, silicon carbonate, zinc sulfate, arsenic gallium, or lead sulfate. Because the semiconductor layer is made of the material having the larger electrical resistance than that of the body portion of the center electrode, breakdown voltage can be reduced from a case where the semiconductor layer is not provided in the center electrode. However, the semiconductor layer is seared by repeated use of the spark plug. Thus, after a long use of the spark plug, the breakdown voltage would not be reduced from the case where the semiconductor layer is not provided.

That is, even if after the spark plug is repeatedly used for a long time, breakdown voltage should be reduced to improve ignitability and ignition performance of the spark plug. Hence, the spark plugs of Yoshinaga et al. and Mogi et al. do not give essential solutions to realize a small breakdown voltage after a long use of the spark plug because wear of the center electrode is liable not to be reduced.

Benedikt et al. disclose in U.S. Pat. No. 6,531,809 a spark plug that guarantees reliable flame kernel formation at high flow rate of air-fuel mixture and in the case of air-fuel mixture inhomogeneity.

The spark plug of Benedikt et al. includes a housing, an insulator nose attached to the housing, a center electrode inserted through the insulator nose and projecting over the insulator nose tip, an intermediate electrode separated from the center electrode by a first spark gap, an insulating body, and a ground electrode attached to the housing. The insulating body is provided between the intermediate electrode and the ground electrode to form a second spark gap in the form of a surface gap at a surface of the insulating body. Because the first and second spark gaps are located in the vicinity of lee sides where the air-fuel mixture flows with lowest flow rate when the air-fuel mixture reaches a high flow rate, the spark plug of Benedikt et al. is capable for growing flame kernel to avoid misfiring.

However, In the spark plug of Benedikt et al. no measure for reduction of breakdown voltage and reduction of wear of the spark plug is carried out.

Further, Matsubara discloses in WO 01/43246 and the corresponding U.S. Pat. No. 6,819,032 a spark plug including, in addition to a ground electrode which faces the end face of an elongated center electrode, auxiliary ground electrodes whose end faces face the circumferential surface of the center electrode and a tubular metallic housing enclosing an insulator that hold the center electrode therein. An object of disposing the auxiliary ground electrodes is not to induce sparking across a gap between the auxiliary ground electrode and the center electrode, but to improve distribution of electric potential and then electric field in vicinity of the end face of the center electrode so as to induce sparking between the ground electrodes and the center electrode at a lower breakdown voltage (discharge voltage).

In a third mode of the Matsubara's invention, the interior diameter of a front end portion of the tubular metallic housing is reduced to increase the area of a front end face. Such a shape of the front end portion of the metallic housing would lead to suppress entry of fuel into the interior of the housing, so that suppression of “carbon fouling”, reduction of wear of the center electrode, and reduction of required electric voltage to induce spark discharge are simultaneously obtained. For example, in a direct-injection-type internal combustion engine, a fuel injection nozzle is directed toward a piston, and fuel hits against the piston and springs back to approach to a spark plug from a position obliquely forward the spark plug while being influenced by tumble and squish. Fuel that reaches the spark plug at such an oblique angle is likely to enter the interior of the housing. In the “carbon fouling” state, carbon generated by ignition of air-fuel mixture has accumulatively adhered to the surface of the insulator. When “carbon fouling” progresses, insulation between the center electrode and the ground electrode is impaired and “inside sparks” (sparks discharged from the center electrode to the tubular metallic housing via the insulator when the insulator is in the “carbon fouling” state) may occur. As a result of this, spark discharge may be disabled and the engine may be stalled.

However, the front end portion of the metallic housing is exposed to high temperature air-fuel mixture and thus is liable to be oxidized. As a result, the service life of the spark plug would be shortened.

Therefore, there is a request for a spark plug for use in Internal combustion engines of automotive vehicles and cogeneration systems which operates with reduced breakdown voltage and reduced rate of spark plug wear and has a long service time.

### SUMMARY OF THE INVENTION

The present invention has been made taking the above mentioned problems into consideration, an object of the present invention is to provide a spark plug that operates with reduced breakdown voltage and reduced rate of spark plug wear and has a long service time.

According to a first aspect of the present invention, there is provided a spark plug that has a longitudinal axis and includes a center electrode, an insulator, a housing, a ground electrode, an auxiliary ground electrode, and a projected portion in the housing. The center electrode has a longitudinal axis aligned with the longitudinal axis of the spark plug and has an end thereof. The insulator has a first end and a second end opposite to the first end thereof along the longitudinal axis and holds the center electrode in a state where the end of the center electrode is protruded from the first end of the insulator. The housing has a first end and a second end opposite to the first end of the housing along the longitudinal axis of the spark plug, the first end of the housing being nearer to the first end of the insulator than the second end of the housing, and has a though-hole which is formed in the housing along the longitudinal axis of the spark plug and has an opening at the first end of the insulator, an inner peripheral surface of the housing defined by the through-hole having an insulator-holding portion where the insulator is held such that the first insulator end protrudes from the first housing end and an hollow portion so that an air pocket is formed between the inner peripheral surface of the hollow portion of the housing and an outer peripheral surface of the insulator. The ground electrode has a first end facing the end of the center electrode to form a first discharge gap at which spark discharge is ignited and a second end joined to the first housing end. The auxiliary ground electrode has a first end facing of the first end of the insulator to form a second discharge gap and a second end joined to the first housing. The projected portion is formed on the hollow portion of the inner peripheral surface of the housing and is projected from the inner peripheral surface of the hollow portion of the housing.

Therefore, when the projection portion is formed on the interior peripheral surface of the housing, the projection portion leads to reduce breakdown voltage in capacitive discharge, and a required electric voltage which is required to be applied between the center electrode and the ground electrode of the spark plug to induce the spark discharge is lowered so that ignitability and ignition performance of the spark plug is improved. Therefore, the spark plug operates with reduced breakdown voltage and reduced rate of spark plug wear and has a long service time.

Further, the projection portion is easily manufactured. In fact, the interior projection portion can be formed by processing of protruding the surface of the through-hole of the housing because, in general, the housing is mode of a metal. Therefore, the spark plug 1 having the housing which is provided with the interior projection portion has a cost advantage due to the simple structure of the spark plug. That is, the projection portion is not prepared as a separate member from the housing, but is a portion formed by mechanical processing.

According to a second aspect of the present invention, there is provided a spark plug that includes the center electrode, the insulator, the housing, the ground electrode, the auxiliary ground electrode, and a projected portion in the housing, wherein the hollow portion of the through-hole of the housing has a first end on a far side of the first end of the housing and a second end at which the opening of the housing is formed, and the projected portion is formed between the first end of the hollow portion and the second end of the hollow portion of the housing.

Therefore, when the interior projection portion is formed at the interior peripheral surface of the housing between ends of the hollow portion which is an empty space formed between the outer peripheral surface of the insulator and the interior peripheral surface of the housing, the projection portion leads to reduce the breakdown voltage in the capacitive discharge, and a required electric voltage which is required to be applied between the center electrode and the ground electrode of the spark plug to induce the spark discharge is lowered so that ignitability and ignition performance of the spark plug is improved. Therefore, the spark plug operates with reduced breakdown voltage and reduced rate of spark plug wear and has a long service time.

Further, the interior projection portion is formed at the interior peripheral surface of the housing between the ends of the hollow portion so that high temperature air-fuel mixture does not reach the projection portion in the combustion chamber of the engine. Hence, the projection portion is not liable to be oxidized. That is, wear of the projection portion is liable to be reduced so that the lifetime of the spark plug is increased.

According to a third aspect of the present invention, there is provided a spark plug that includes the center electrode, the insulator, the housing, the ground electrode, the auxiliary ground electrode, and a projected portion in the housing, when a first length which is a minimum length between the inner peripheral surface of the projected portion of the housing and the outer peripheral surface of the insulator and a second length of the first discharge gap formed between the end of the center electrode and the first end of the ground electrode, the first length is shorter than the second length.

In such configuration of the spark plug, the interior projection portion of the housing plays a central rule for generating the back electrode effect because if the first length is longer than the second length, the interior projection portion of the housing cannot serve as the back electrode. The interior projection portions serve as the back electrodes which are members forming the hollow by which electric field originated from the center electrode is concentrated near the first spark gap. The distribution of electric field generated by applying electric voltage to the center electrode will be bounded by the pocket portion so that electric field is concentrated near the first spark gap. Thus, the interior projection portions lead to reduce the breakdown voltage in the capacitive discharge, and the required electric voltage which is required to be applied between the center electrode and the ground electrode of the spark plug to induce the spark discharge is lowered so that ignitability and ignition performance of the spark plug is improved.

According to a fourth aspect of the present invention, there is provided a spark plug that includes the center electrode, the insulator, the housing, the ground electrode, the auxiliary ground electrode, and a projected portion in the housing, wherein the projected portion formed on the inner peripheral surface of the housing has an edge at which a diameter of the through-hole is suddenly changed.

Therefore, the edge of the projected portion enhances a tendency of concentration of distribution of electric field originated from the center electrode to the ground electrode or the auxiliary ground electrode to vicinity of the end portion of the center electrode. Therefore, the spark plug for use in internal combustion engines of automotive vehicles and cogeneration systems according to the present embodiment operates with reduced breakdown voltage and reduced rate of spark plug wear and has a long service time and cost advantage.

Further in the spark plug according to the present invention, the length M2 of the clearance formed between the projection portion of the housing and the circumferential surface of the insulator and the length G1 of the first spark gap formed between the center electrode and the ground electrode 1 satisfy the following relation: M2<G1. Hence, it is ensured that the projection portion can serve as a back electrode that is a key member for generating a beck electrode effect. Therefore, the spark plug for use in internal combustion engines of automotive vehicles and cogeneration systems according to the present embodiment operates with reduced breakdown voltage and reduced rate of spark plug wear and has a long service time and cost advantage.

Further in the spark plug according to the present invention, when a length of the hollow portion is defined as a length between the first end of the hollow portion and the second end of the hollow portion of the housing along the longitudinal axis of the center electrode, and a depth of the projected portion is defined as a minimum length between the first end of the hollow portion and the projected portion, the depth of the projection portion is larger than one third of the length of the hollow portion. Hence, it is ensured that the projection portion can serve as a back electrode.

### BRIEF DESCRIPTION OF THE DRAWINGS

The present invention will be understood more fully from the detailed description to be given hereinbelow and from the accompanying drawings of the preferred embodiment of the invention, which is not taken to limit the invention to the specific embodiments but should be recognized for the purpose of explanation and understanding only.

In the drawings:

FIG. 1 is a partial cross-sectional view showing an overall structure of a spark plug according to a first embodiment of the present invention;

FIG. 2 is an enlarged partial cross-sectional view showing an ignition portion of the spark plug according to the first embodiment including a cylindrically shaped housing provided with an interior projection portion, a cylindrically shaped insulator attached to the housing, an elongated center electrode inserted through the insulator having a tip end face and a circumferential surface, a ground electrode attached to the housing and facing the tip end face of the center electrode, and an auxiliary ground electrode whose tip end face facing the circumferential surface of the center electrode;

FIG. 3 is a plane view showing the spark plug according to the first embodiment taken along a line A-A of FIG. 2;

FIG. 4 is a front view showing the ignition portion of the spark plug according to the first embodiment, viewed from an arrow B of FIG. 2;

FIG. 5 is an enlarged partial cross sectional view shoving dimensional parameters of the ignition portion of the spark plug according to the first embodiment having a configuration specified by dimensions G1, L0-L3, and M1-M2;

FIG. 6 is an enlarged partial cross-sectional view showing a ignition portion of a spark plug according to a comparative art including a cylindrically shaped housing, a cylindrically shaped insulator attached to the housing, an elongated center electrode inserted through the insulator having a tip end face, and a ground electrode attached to the housing and facing the tip end face of the center electrode;

FIG. 7 is an illustrative view showing equipotential curves and electric fields, the equipotential curves being dense and thus the electric field being intense in the vicinity of the ignition portion of the spark plug having the interior projection portion on a interior peripheral surface of the cylindrically shaped housing between ends of a pocket portion which is a empty space formed between the outer peripheral surface of the cylindrically shaped insulator and the interior peripheral surface of the cylindrically shaped housing;

FIG. 8 is an illustrative view showing equipotential curves and electric fields, the equipotential curves being not dense and thus the electric field being not intense in the vicinity of the ignition portion of the spark plug having the housing provided with no interior projection portion;

FIG. 9 is an illustrative view showing equipotential curves and electric fields, the equipotential curves being dense and thus the electric field being intense in the vicinity of the ignition portion of the spark plug having the interior projection portion on a interior peripheral surface of the cylindrically shaped housing near an end of the housing;

FIG. 10 is an illustrative view showing inside spark phenomena which may be caused between the center electrode and an interior projection portion of the housing;

FIG. 11 is an illustrative view showing effect of an auxiliary ground electrode which suppresses the inside spark from occurring between the center electrode and the interior projection portion of the housing;

FIG. 12 is a graph showing a relationships between pressure in a combustion chamber of an internal combustion engine and breakdown electric voltages required to ignite spark discharge in the spark plug according to the first embodiment (solid line b) and one according to the comparative art (dot line a);

FIG. 13 is a plane view showing the spark plug according to a modification of the first embodiment taken along a line A-A of FIG. 2;

FIG. 14 is an enlarged partial cross-sectional view showing an ignition portion of the spark plug according to a second embodiment including a cylindrically shaped housing provided with an interior projection portion, a cylindrically shaped insulator attached to the housing, an elongated center electrode inserted through the insulator having a tip end face and a circumferential surface, a ground electrode attached to the housing and facing the tip end face of the center electrode, and an auxiliary ground electrode whose tip end face is facing the circumferential surface of the center electrode;

FIG. 15 is an enlarged partial cross-sectional view showing a ignition portion of the spark plug according to a third embodiment including a cylindrically shaped housing provided with an interior projection portion, a cylindrically shaped insulator attached to the housing, an elongated center electrode inserted through the insulator having a tip end face and a peripheral side surface, a ground electrode attached to the housing and facing the tip end face of the center electrode, and an auxiliary ground electrode whose tip end face faces the peripheral side surface of the center electrode; and

FIG. 16 is an enlarged partial cross-sectional view showing the ignition portion of the spark plug according to a fourth embodiment including a cylindrically shaped housing provided with an interior projection portion, a cylindrically shaped insulator attached to the housing, an elongated center electrode inserted through the insulator having a tip end face and a peripheral side surface, a ground electrode attached to the housing and facing the tip end face of the center electrode, and an auxiliary ground electrode whose tip end face faces the peripheral side surface of the center electrode.

### DESCRIPTION OF THE PREFERRED EMBODIMENTS

Preferred embodiments of the present invention will be explained below with reference to attached drawings, Identical parts are denoted by the same reference numerals throughout the drawings.

it should be noted that, for the sake of clarity and understanding, identical components having identical functions in the different embodiments of the invention have been marked with the same reference numerals in each of figures.

### First Embodiment

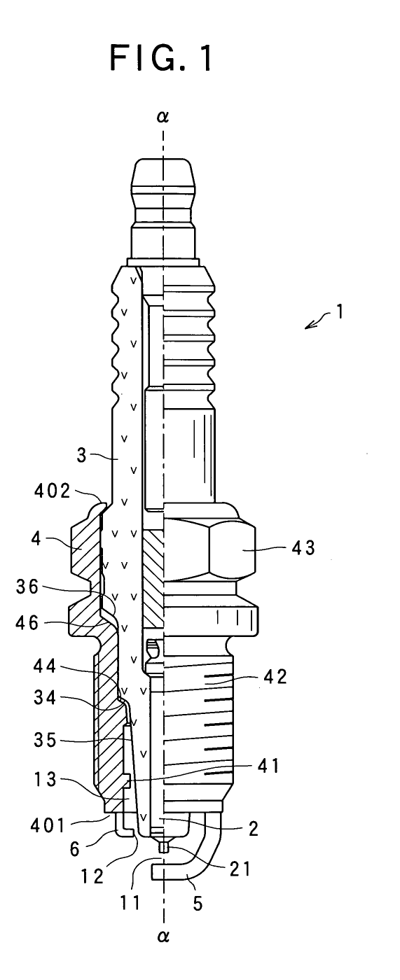

Referring to FIGS. 1-12, a first embodiment of the present invention will be described.

FIG. 1 is a partial cross-sectional view showing an overall structure of a spark plug according to a first embodiment of the present invention.

The spark plug 1 is designed for use in an internal combustion engine (it may sometimes be abbreviated simply to “engine” hereinafter) of an automotive vehicle or a cogeneration system, and is installed within a combustion chamber of the engine. Specifically, the spark plug 1 is designed to ignite air-fuel mixture within the combustion chamber of the engine.

As shown in FIG. 1, the spark plug 1 has an axis α and includes a cylindrical center electrode 2, an insulator 3, a housing 4, and a ground electrode 5.

The housing (metallic shell) 4 has a first end 401 and a second end 402 opposite to the first end 401 in the axis α of the spark plug 1. The housing 4 has a tubular shape whose center axis being identical with the axis α of the spark plug 1, so a through-bore is formed along the axis α of the spark plug 1. The cross-section of the through-hole perpendicular to the axis α of the spark plug 1 is substantially a circular shape. The housing 4 also has a thread portion 42 on an exterior peripheral surface thereof to be fixed to the engine.

The housing 4 also has a hexagonal portion 43 on the exterior peripheral surface thereof near the second end 402 of the housing 4 to screw the spark plug 1 into the combustion chamber of the engine using a wrench. Further, the housing 4 has a first inner shoulder 44 and a second inner shoulder 46 which are formed on an interior peripheral surface of the housing 4. The first inner shoulder 44 is closer to the first end 411 of the housing 4 than the second inner shoulder 46.

The insulator 3 has a longitudinal axis being identical with the axis α of the spark plug 1 along which a first and a second ends of the insulator 3 positioned oppositely to each other are provided. The first end of the insulator 3 is closer to the first end 401 of the housing 4 than the second end of the insulator 3. The insulator 3 is retained in the through-bore of the housing 4 so that the first and second ends of the insulator 3 protrude from the first end 401 and the second end 402 of the housing 4, respectively. The insulator 3 has formed therein a central through-bore that extends along the axis α of the spark plug 1.

The interior peripheral surface of the though-bore of the housing 4 has a small diameter portion in the near side of the first end 401, and a large diameter portion in the near side of the second end 402. The large diameter portion is continued to a first opening at the second end 402 of the housing 4. The small diameter portion is formed between the first inner shoulder 44 and a second opening of the though-bore of the housing 4 formed at the first end 401. The small diameter portion further has an interior projection portion 41 at which the diameter of though-bore of the housing 4 becomes smaller than the remaining part of the small diameter portion. The interior projection portion 41 is positioned between the opening of the though-bore of the housing 4 at the first end 401 and the first inner shoulder 44. In the present embodiment, the interior projection portion 41 is located near the middle of the small diameter portion, but slightly closer to the first end 401 of the though-bore of the housing 4 than the other end of the small diameter portion near the first inner shoulder 44. During ignition of the air-fuel mixture, the interior projection portion 41 serves as a back electrode which concentrates electric field to an ignition portion of the spark plug where spark discharge is mainly generated. That is, a pocket portion 13 is formed inside the though-bore of the housing 4 which serves as a hollow of the end portion 21 of the center electrode 2. The hollow is surrounded by the circumferential surface of the insulator 3, interior peripheral surface of though-bore of the housing 4 and the interior projection portion 41 of the housing. The distribution of electric field generated by applying electric voltage to the center electrode 2 will be bounded by the pocket portion 13 so that electric field is concentrated near the first spark gap 11. This fact will be explained referring to FIGS. 7 to 9.

The insulator 3 also has a first outer shoulder 34 and a second outer shoulder 36. The first and second outer shoulder 34 and 36 are formed on an exterior periphery of the insulator 3, and engage respectively with the first and the second inner shoulders 44 and 46 of the housing 4.

The insulator 3 has a tapered portion 35 which is provided between the first inner shoulder 44 and the first end of the insulator 3 and is designed to be tapered down as approaching to the first end thereof along the axis α of the spark plug 1. The tapered portion 35 may also be referred to as a leg portion. The exterior periphery of the tapered portion 35 and the inner periphery of the small diameter portion of the hosing 4 are arranged by interposing the pocket portion 13 in the diameter direction in the cross section of the spark plug 1.

The center electrode 2 is secured in the central through-bore of the insulator 3. The center electrode 2 has an end portion 21 protruding from the first end of the insulator 3.

The ground electrode 5 has one end joined to the first end 401 of the housing 4 and the other end that faces an end face of the end portion of the center electrode 2 to form a first spark gap 11 between the end face of the center electrode 2 and the ground electrode 5. The ground electrode 5 is extended from the one end at which the ground electrode 5 is joined to the housing 4 in a parallel direction with the axis α of the spark plug 1, is bent at a midway, and is extended toward the axis α of the spark plug 1. Thus, the ground electrode 5 is shaped like a letter L in a cross section containing the axis α of the spark plug 1.

The auxiliary ground electrode 6 has one end joined to the first end 401 of the housing 4 and the other end that faces a circumferential surface of the insulator 3 to from a second spark gap 12 between the auxiliary ground electrode 6 and the insulator 3.

One of the reasons for providing the spark plug 1 with the auxiliary ground electrode 6 is to avoid so-called carbon fouling. At the time of regular operation of the internal combustion engine in which the engine is rotated at higher engine speed than a predetermined engine speed at a predetermined temperature, an ignition portion of the spark plug which includes the first spark gap 11 and the second spark gap 12 is greatly heated and the surface temperature around the ignition portion of the spark plug positioned inside the combustion chamber rises to approximately 500 degrees Celsius. Therefore, carbon adhered to the surface of the insulator 3 is burned and the carbon will not be accumulated on the surface of the insulator 3. That is, no carbon fouling occurs. However, in the case of a low load of the engine where the temperature of the engine is low and the engine speed is also low, the temperature of the surface of the insulator 3 does not rise, carbon generated by combustion of the air-fuel mixture in the combustion chamber adheres to the surface of the insulator 3 and is accumulated on the surface of the insulator 3 so that the surface of the insulator 3 undergoes carbon fouling. When the carbon fouling is caused, insulation between the center electrode 2 and the ground electrode 5 is deteriorated to disable spark discharge therebetween and an inside spark may occur during ignition of the air-fuel mixture. The inside spark here denotes a spark which is discharged from the center electrode 2 to the housing 4 via the insulator 3, when the surface of the insulator 3 is fouled with carbon deposit, instead of across the first spark gap 11 between the center electrode 2 and the ground electrode 5.

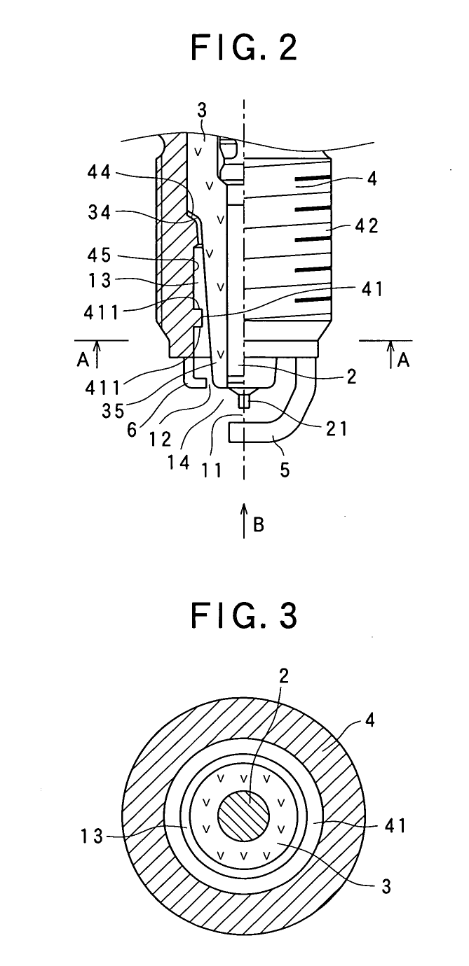

Referring to FIG. 2, a theoretical explanation of the usefulness of the auxiliary ground electrode 6 for avoiding carbon fouling will be given.

FIG. 2 is an enlarged partial cross-sectional view showing an ignition portion of the spark plug according to the first embodiment including the housing 4 provided with the interior projection portion 41 at an inner peripheral surface 45 of the small diameter portion of the housing 4, the insulator 3 attached to the housing 4, the center electrode 2 inserted through the insulator 3 having a tip end face and a circumferential surface, the ground electrode 5 attached to the housing 4 and facing the tip end face of the center electrode 2, and the auxiliary ground electrode 6 whose tip end face faces the circumferential surface of the center electrode 2.

The first spark gap 11 is formed between the end portion 21 of the center electrode 2 and the ground electrode 5. The second spark gap 12 is formed between an end face of the auxiliary ground electrode 6 and the circumferential surface of the insulator 3. Further, a third spark gap 14 is formed between the end portion 21 of the center electrode 2 and the insulator 3.

When the carbon fouling occurs, that is, carbon generated by combustion of the air-fuel mixture in the combustion chamber adheres to the surface of the insulator 3 and is accumulated on the surface of the insulator 3, spark discharge starts between the auxiliary ground electrode 6 and the end portion 21 of the center electrode 2 via a surface of the first end of the insulator 3. This discharge is sometimes called semi-surface discharge. In the surface discharge, spark flies across the second spark gap 12 and then runs along the surface of the insulator 3. After the surface discharge is repeated some times, carbon accumulated on the surface of the insulator 3 is burned off. So, the surface of the insulator is restored from the carbon fouling state to a clean state. Hence, the breakdown voltage of the insulator 3 against the semi-surface discharge is returned to a proper value and insulation in the third spark gap 14 is recovered. As a result, carbon fouling is dissolved and spark discharge is caused in the first spark gap 11 between the center electrode 2 and the ground electrode 5.

Therefore, the auxiliary ground electrode 6 assists to generate spark discharge in the first spark gap 11 between the end portion 21 of the center electrode 2 and the ground electrode 5. Only in a carbon fouling state where carbon is accumulated on the surface of the insulator 3, the semi-surface discharge is generated in the third spark gap 14 to ignite air-fuel mixture in the combustion chamber of the engine. Because air-fuel mixture is ignited by spark discharge in the first spark gap 11 between the center electrode 2 and the ground electrode 5, the spark plug 1 has improved ignitabililty.

Further, to increase the output and improve the fuel economy of the engine, it is possible that the spark plug 1 is configured to determine ion current induced in the combustion chamber to detect combustion condition. During combustion of the air-fuel mixture within the combustion chamber, positive and negative ions are created due to ionization of the air-fuel mixture. The positive and negative ions are absorbed by the ground electrode 5 and/or the auxiliary ground electrode 6 and the center electrode 2 of the spark plug 1, respectively. That is, ion current flowing from the center electrode 2 to the ground electrode 5 and/or the auxiliary ground electrode 6 is created. When the ion current is determined, it is possible to detect combustion condition.

In the present embodiment, as can be seen in FIG. 2, the interior projection portion 41 has a rectangular-shaped cross section along the axis α of the spark plug 1 and has two right angled shoulders 411. In this case, the shoulders 411 may be also referred to as edge portions.

FIG. 3 is a plane view taken along a line A-A of FIG. 2 showing the spark plug according to the first embodiment, All surfaces of the center electrode 2, the insulator 3, the small diameter portion 41 of the housing 4, and the though-bore of the housing 4 are concentrically formed, as shown in FIG. 3. In the present embodiment, the interior projection portion 41 is continuously formed through 360 degrees of rotation in the though-bore of the housing 4.

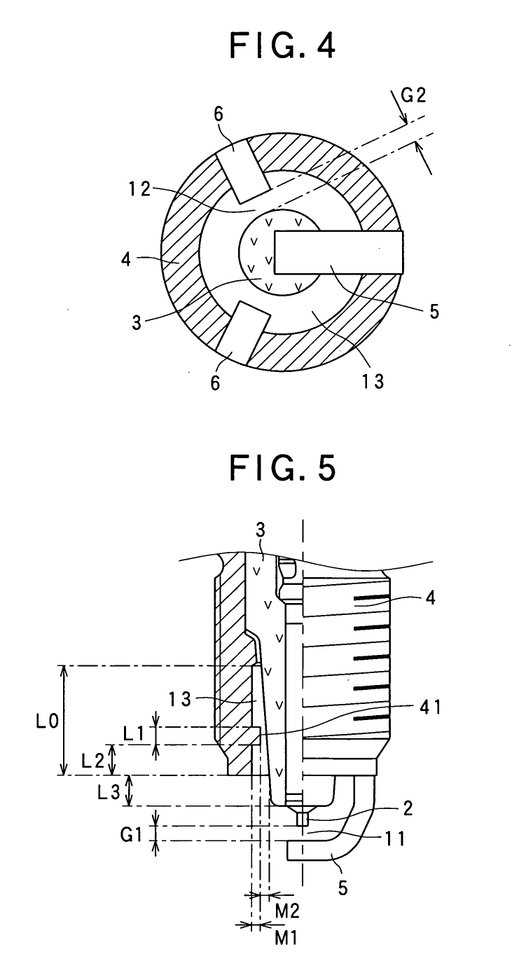

FIG. 4 is a front view showing the ignition portion of the spark plug according to the first embodiment, viewed from an arrow B of FIG. 2.

There are two auxiliary ground electrodes 6 formed. Each of the auxiliary ground electrodes 6 has one end joined to the first end 401 of the housing 4 and the other end that faces a circumferential surface of the insulator 3 to form a second spark gap 12 between the auxiliary ground electrode 6 and the insulator 3. The two auxiliary ground electrodes 6 are respectively arranged in a position off by 120 degree from the ground electrode 5 and each auxiliary ground electrode 6 is arranged in a position off by 120 degree from each other.

The length G2 of the second spark gap formed between the end face of the auxiliary ground electrode 6 (i.e. opposite to the end joined to the housing 4) and the end portion 21 of the center electrode 2 is about 0.5 mm.

FIG. 5 is an enlarged partial cross sectional view showing dimensional parameters of the ignition portion of the spark plug according to the first embodiment having a configuration specified by dimensions G1, L0-L3, and M1-M2. In FIG. 5, the auxiliary ground electrode 6 is not shown for simplicity.

L0, which represents the length of the pocket portion 13 formed between the circumferential surface of the tapered portion 35 of the insulator 3 and the inner peripheral surface 45 of the small diameter portion of the housing 4 along the axis α of the spark plug 1, is about 8 mm.

L1, which represents the length of the interior projection portion 41 along the axis α of the spark plug 1, is about 1 mm.

L2, which represents the length between one of the shoulders 411 closer to the first end 401 of the housing 4 and the first end 401 of the housing 4 along the axis α of the spark plug 1, is about 3 mm.

L3, which represents the protruded length of the insulator 3 from the first end 401 of the housing 4 along the axis α of the spark plug 1, is about 2.5 mm.

G1, which represents the length of the first spark gap 11 formed between the end portion 21 of the center electrode 2 and the surface of the ground electrode 5 facing to the end face of the center electrode 2 along the axis α of the spark plug 1, is about 1.1 mm.

M1, which represents a projected length of the interior projection portion 41 in a perpendicular direction to the inner peripheral surface 45 of the small diameter portion of the housing 4, is about 1.0 mm.

M2, which represents the length of a clearance formed between the interior projection portion 41 of the housing 4 and the circumferential surface of the insulator 3, is about 0.5 mm.

It should be noted that, in the spark plug 1 according to the present embodiment, the length L0 of the pocket portion 13 and the inner peripheral surface 45 of the small diameter portion of the housing 4 along the axis α of the spark plug 1 and the length L2 between one of the shoulders 411 and the first end 401 of the housing 4 satisfy the following relation.

$$L 2 > \frac{1}{3} L 0. \qquad ( 1 )$$

Further, it should be noted that, in the spark plug 1 according to the present embodiment, the length M2 of the clearance formed between the interior projection portion 41 of the housing 4 and the circumferential surface of the insulator 3 and the length G1 of the first spark gap 11 formed between the end portion 21 of the center electrode 2 and the surface of the ground electrode 5 facing to the end face of the center electrode 2 along the axis α of the spark plug 1 satisfy the following relation:

M2<G1. (2)

When at least one of the relations (1) and (2) is satisfied, it is ensured that the interior projection portion 41 can serve as a back electrode that is a key member for generating a beck electrode effect. The back electrode effect will be explained below it should be noted here that the back electrode effect leads to concentrate energy of electric fields in the vicinity of the first spark gap formed between the center electrode 2 and the ground electrode 5 so as to reduce break down voltage.

### OPERATIONS AND ADVANTAGES

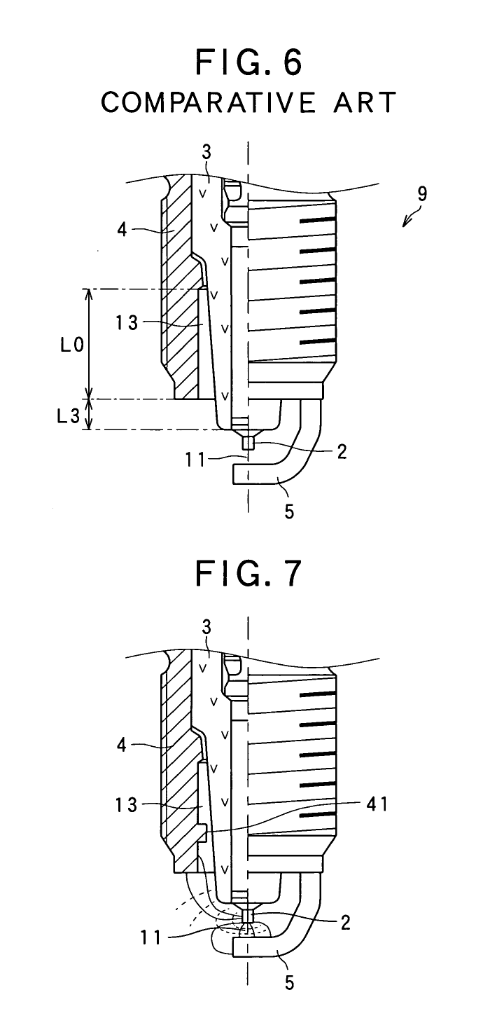

Referring to FIGS. 6-12, operations and advantages of the spark plug 1 according to the present embodiment will be explained.

In the spark plug 1 according to the first embodiment, the housing 4 is provided with the interior projection portion 41 at the interior peripheral surface of the cylindrically shaped housing 4 between ends of the pocket portion 13 which is a empty space formed between the outer peripheral surface of the cylindrically shaped insulator 3 and the interior peripheral surface of the cylindrically shaped housing 4. The interior projection portion 41 serves as the back electrode which is one of members forming the hollow by which electric field originated from the center electrode 2 is concentrated near the first spark gap 11. The hollow is surrounded by the circumferential surface of the insulator 3, interior peripheral surface of though-bore of the housing 4 and the interior projection portion 41 of the housing. The distribution of electric field generated by applying electric voltage to the center electrode 2 will be bounded by the pocket portion 13 so that electric field is concentrated near the first spark gap 11. Hence, a probability of emission of electron from the end portion 21 of the center electrode 2 is increased so that ignitability of capacitive discharge is improved. The inductive discharge occurs after the capacitive discharge. In general, breakdown voltage to be applied to the spark gap to cause the capacitive discharge in the spark gap is much higher than breakdown voltage in the inductive discharge, and the breakdown voltage in the capacitive discharge is referred as breakdown voltage at the spark gap. Thus, the interior projection portion 41 leads to reduce the breakdown voltage in the capacitive discharges and a required electric voltage which is required to be applied between the center electrode 2 and the ground electrode 6 of the spark plug 1 to induce the spark discharge is lowered so that ignitability and ignition performance of the spark plug 1 is improved.

FIG. 6 is an enlarged partial cross-sectional view showing the ignition portion of a spark plug 9 according to a comparative art including the cylindrically shaped housing 4, the cylindrically shaped insulator 3 attached to the housing 4, the elongated center electrode 2 inserted through the insulator 3 having a tip end face, and the ground electrode 5 attached to the housing 4 and facing the tip end face of the center electrode 2.

Comparing the spark plug 9 according to the comparative art with the spark plug 1 according to the present embodiment, the housing 4 of the spark plug 9 does not have the interior projection portion 41 and the spark plug 9 is not provided with the auxiliary ground electrode 6. L0 representing the length of the pocket portion 13 is about 8 mm, so that the length of the pocket portion 13 of the spark plug 9 has the same dimension with that of the spark plug 1. L3, which represents a protruded length of the insulator 3 from the first end 401 of the housing 4 along the axis α of the spark plug 1, is about 2.5 mm, so that the protruded length of the insulator 3 of the spark plug 9 from the first end 401 of the housing 4 along the axis α of the spark plug 1 has also the same dimension with that of the spark plug 1. G1, which represents the length of the first spark gap 11 formed between the end portion 21 of the center electrode 2 and the surface of the ground electrode 5 facing to the end face of the center electrode 2 along the axis α of the spark plug 1, is about 1.1 mm, which is the same dimension with that of the spark plug 1 according to the present embodiment. Other dimension parameters agree with those of the spark plug 1 according to the present embodiment.

FIG. 7 is an illustrative view showing equipotential curves and electric fields, the equipotential curves being dense and thus the electric field being intense in the vicinity of the ignition portion of the spark plug 1 having the interior projection portion 41 at the interior peripheral surface of the cylindrically shaped housing 4 between ends of the pocket portion 13 which is a empty space formed between the outer peripheral surface of the cylindrically shaped insulator 3 and the interior peripheral surface of the cylindrically shaped housing 4.

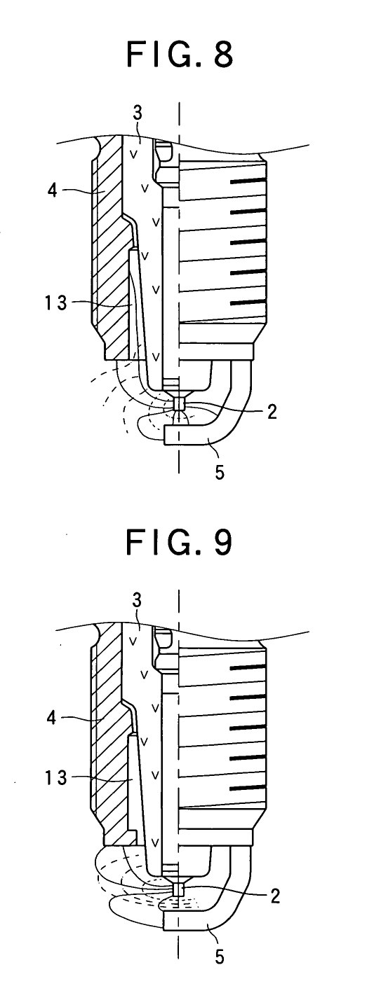

FIG. 8 is an illustrative view showing equipotential curves and electric fields, the equipotential curves being not dense and thus the electric field being not intense in the vicinity of the ignition portion of the spark plug 9 having the housing 4 provided with no interior projection portion.

FIG. 9 is an illustrative view showing equipotential curves and electric fields, the equipotential curves being dense and thus the electric field being intense in the vicinity of the ignition portion of a modification of the spark plug 1. In the modification of the spark plug 1, the interior projection portion 41 is provided at the interior peripheral surface of the cylindrically shaped housing 4 near an end of the pocket portion 13 which is a empty space formed between the outer peripheral surface of the cylindrically shaped insulator 3 and the interior peripheral surface of the cylindrically shaped housing 4.

Comparing the distribution of the equipotential curves shown in FIG. 7 with those in FIG. 8, it is can be found that the interior projection portion 41 leads to concentrate the electric field originated from the end portion 21 of the center electrode 2 to the vicinity of the center electrode 2 and the ground electrode 5 between which spark discharge is caused. That is, the distribution of the equipotential curves shown in FIG. 8 which is obtained in a case where no injection projection portion 41 exists penetrates deeply inside the pocket portion 13. In contrast to this, the equipotential curves shown in the case shown FIG. 7 are not widely distributed and electric field crossing the equipotential curves at right angle is densely concentrated in vicinity of the first spark gap 11 formed between the center electrode 2 and the ground electrode 5 due to the so-called “back electrode effect”.

Comparing the distribution of the equipotential curves shown in FIG. 7 with those in FIG. 9, it can be seen that the difference of the position of the interior projection portion 41 in the pocket portion 13 gives the difference of density of the equipotential curves in the vicinity of the first spark gap 11. That is, the density of the equipotential curves in the vicinity of the first spark gap 11 in FIG. 7 is larger than that in FIG. 9. This is because, in the case of FIG. 9 where the interior projection portion 41 is provided at the interior peripheral surface of the cylindrically shaped housing 4 near the end of the pocket portion 13, the equipotential curves do not tendency to penetrate inside the pocket portion 13, and thus the equipotential curves spreads in a radial direction in a plane perpendicular to the axis α of the spark plug 1. So, the equipotential curves shown in the case shown FIG. 7 are not widely distributed and the electric field is densely concentrated in vicinity of the first spark gap 11 formed between the center electrode 2 and the ground electrode 5.

Therefore, when the interior projection portion 41 is formed at the interior peripheral surface of the cylindrically shaped housing 4 between ends of the pocket portion 13 which is a empty space formed between the outer peripheral surface of the cylindrically shaped insulator 3 and the interior peripheral surface of the cylindrically shaped housing 4, the interior projection portion 41 leads to reduce the breakdown voltage in the capacitive discharge, and a required electric voltage which is required to be applied between the center electrode 2 and the ground electrode 6 of the spark plug 1 to induce the spark discharge is lowered so that ignitability and ignition performance of the spark plug 1 is improved. Therefore, the spark plug 1 operates with reduced breakdown voltage and reduced rate of spark plug wear and has a long service time.

As already mentioned, in the spark plug 1 according to the present embodiment, the length M2 is shorter than the length G1. Where, M2 represents the length of the clearance formed between the interior projection portion 41 of the housing 4 and the circumferential surface of the insulator 3. G1 represents the length of the first spark gap 11 formed between the end portion 21 of the center electrode 2 and the surface of the ground electrode 5 facing to the end face of the center electrode 2 along the axis α of the spark plug 1. In such configuration of the spark plug 1, the interior projection portion 41 of the housing 4 plays a central rule for generating the back electrode effect because if the length M2 is longer than the length G1, the interior projection portion 41 of the housing 4 cannot serve as the back electrode. The interior projection portions 41 serve as the back electrodes which are members forming the hollow by which electric field originated from the center electrode 2 is concentrated near the first spark gap 11. The distribution of electric field generated by applying electric voltage to the center electrode 2 will be bounded by the pocket portion 13 so that electric field is concentrated near the first spark gap 11. Thus, the interior projection portions 41 lead to reduce the breakdown voltage in the capacitive discharge, and a required electric voltage which is required to be applied between the center electrode 2 and the ground electrode 6 of the spark plug 1 to induce the spark discharge is lowered so that ignitability and ignition performance of the spark plug 1 is improved.

Further, the length M2 of the clearance formed between the interior projection portion 41 of the housing 4 and the circumferential surface of the insulator 3 and the length G1 of the first spark gap 11 formed between the center electrode 2 and the ground electrode 5 satisfy the mathematical relation (2), that is, M2<G1, it is also ensured that the interior projection portion 41 facilitates the beck electrode effect.

Further, the interior projection portion 41 is formed at the interior peripheral surface of the cylindrically shaped housing 4 between the ends of the pocket portion 13 so that high temperature air-fuel mixture does not reach the interior projection portion 41 in the combustion chamber of the engine. Hence, the interior projection portion 41 is not liable to be oxidized. That is, wear of the interior projection portion 41 is liable to be reduced so that the lifetime of the spark plug is increased. In particular, when the length L0 of the pocket portion 13 and the inner peripheral surface 45 of the small diameter portion of the housing 4 along the axis α of the spark plug 1 and the length L2 between one of the shoulders 411 and the first end 401 of the housing 4 satisfy the following relation (1), that is, L2>(⅓)L0, it is ensured that the interior projection portion 41 facilitates the beck electrode effect and the high temperature air-fuel mixture does not reach the interior projection portion 41 in the combustion chamber of the engine.

Further, the interior projection portion 41 is easily manufactured. In fact, the interior projection portion 41 can be formed by processing of protruding the surface of the through-hole of the housing 4 because, in general, the housing is mode of a metal. That is, the projection portion is not prepared as a separate member from the housing, but is a portion formed by mechanical processing. Therefore, the spark plug 1 having the housing 4 which is provided with the interior projection portion 41 has a cost advantage due to the simple structure of the spark plug 1.

However, the interior projection portion 41 has the possibility to serve as an electrode to which an inside spark discharged from the center electrode 2 arrives via the circumferential surface of the insulator 3 when the circumferential surface of the insulator 3 is in a carbon fouling state.

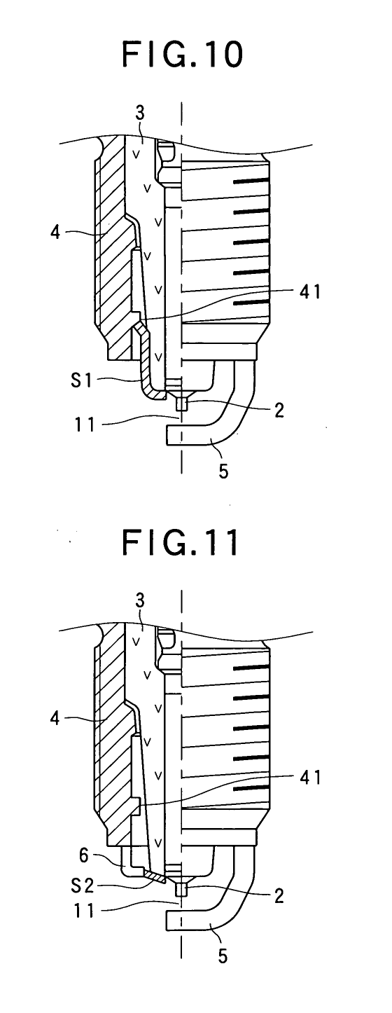

FIG. 10 is an illustrative view showing inside spark phenomena which may be caused between the center electrode 2 and an interior projection portion 41 of the housing 4.

To suppress the inside spark between the center electrode 2 and an interior projection portion 41 of the housing 4, the spark plug 1 according to the present embodiment is provided with the auxiliary ground electrode 6.

FIG. 11 is an illustrative view showing effect of the auxiliary ground electrode 6 which suppresses occurrence of the inside spark between the center electrode 2 and the interior projection portion 41 of the housing 4 via the circumferential surface of the insulator 3.

As shown in FIG. 11 and discussed above, because only the semi-surface discharge is generated at the third spark gap 14 formed between the end portion 21 of the center electrode 2 and the insulator 3, the inside spark is caused between the center electrode 2 and the auxiliary ground electrode 6 via the second spark gap 12 formed between the auxiliary ground electrode 6 and the insulator 3 and the third spark gap 13. Hence, it is possible to suppresses occurrence of the inside spark between the center electrode 2 and the interior projection portion 41 of the housing 4 via the circumferential surface of the insulator 3 so that ignitablity of the spark plug 1 is improved.

Further, the interior projection portion 41 according to the present embodiment has the edge portions 411. This fact enhances a tendency of concentration of distribution of electric field originated from the center electrode 2 to the ground electrode 5 or the auxiliary ground electrode 6 to the vicinity of the end portion 21 of the center electrode 2. Therefore, the spark plug 1 for use in internal combustion engines of automotive vehicles and cogeneration systems according to the present embodiment operates with reduced breakdown voltage and reduced rate of spark plug wear and has a long service time and cost advantage.

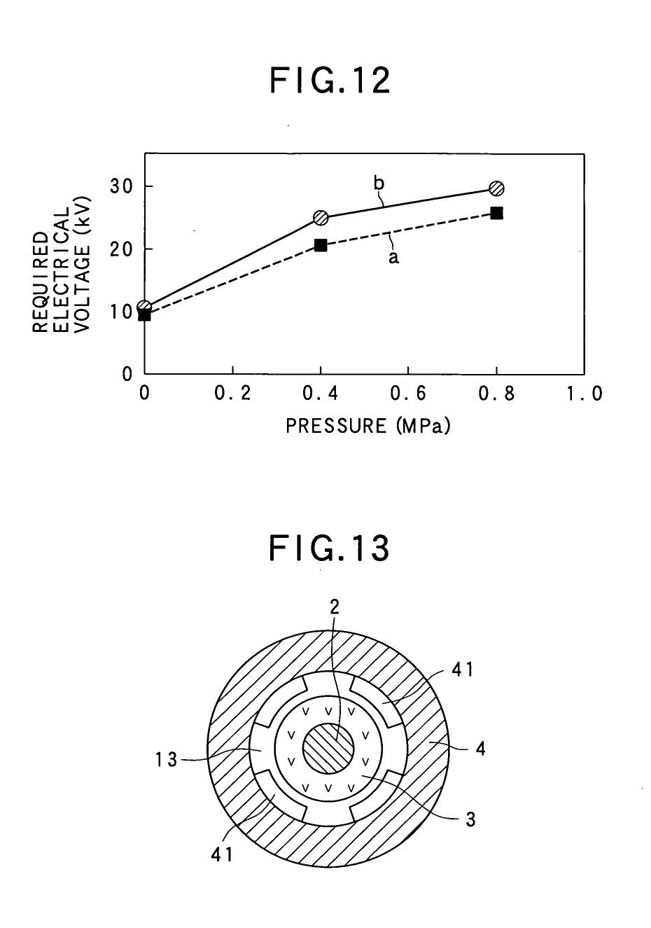

FIG. 12 is a graph showing a relationships between pressure in a combustion chamber of an internal combustion engine and breakdown electric voltages required to ignite spark discharge in the spark plug 1 according to the first embodiment (solid line b) and the spark plug 9 according to the comparative art (dot line a)

In FIG. 12, a broken line b represents a change in breakdown electric voltage required to ignite spark discharge in the spark plugs 1 against pressure in the combustion chamber. A solid line a represents a change in breakdown electric voltage required to ignite spark discharge in the spark plugs 9 against pressure.

It is easily seen that breakdown electric voltages of the spark plugs 1 are lower than those of the spark plug 9 in pressure range from 0 MPa to 0.8 MPa. Hence, it is proved that the interior projection portion 41 leads to reduce the breakdown voltage in the capacitive discharge, and a required electric voltage which is required to be applied between the center electrode 2 and the ground electrode 6 of the spark plug 1 to induce the spark discharge is lowered. Therefore, ignitability and ignition performance of the spark plug 1 is improved

### MODIFICATION

Referring to FIG. 13, a modification of the first embodiment of the present invention will be explained.

FIG. 13 is a plane view showing the spark plug according to the modification of the first embodiment taken along a line A-A of FIG. 2.

In the modification of the first embodiment, the only difference from the first embodiment is based on a shape of the interior projection portion 41 of the housing 4. Thus, detailed discussion about the constituents of the spark plug having the same function and the structure with those used in the first embodiment will be omitted.

The housing 4 according to the modification of the first embodiment includes four interior projection portions 41 with each interior projection portions 41 arranged in a position off by 90 degree from each other.

The interior projection portions 41 serve as the back electrodes which are members forming the hollow by which electric field originated from the center electrode 2 is concentrated near the first spark gap 11. The distribution of electric field generated by applying electric voltage to the center electrode 2 will be bounded by the pocket portion 13 so that electric field is concentrated near the first spark gap 11. Thus, the interior projection portions 41 lead to reduce the breakdown voltage in the capacitive discharge, and a required electric voltage which is required to be applied between the center electrode 2 and the ground electrode 6 of the spark plug 1 to induce the spark discharge is lowered so that ignitability and ignition performance of the spark plug 1 is improved.

Therefore, in the spark plug according to the modification of the first embodiment, the same advantages with the first embodiment can be obtained.

### Second Embodiment

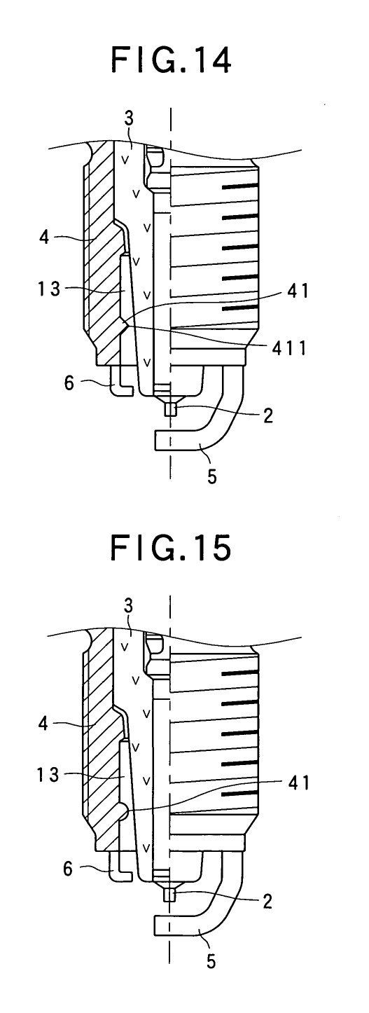

Referring to FIG. 14, a second embodiment of the present invention will be explained.

FIG. 14 is an enlarged partial cross-sectional view showing an ignition portion of the spark plug 1 according to the second embodiment including the cylindrically shaped housing 4 provided with the interior projection portion 41, the cylindrically shaped insulator 3 attached to the housing 4, the elongated center electrode 2 inserted through the insulator 3 having the tip end face and the circumferential surface, the ground electrode 5 attached to the housing 4 and facing the tip end face of the center electrode 2, and the auxiliary ground electrode 6 whose tip end face faces the circumferential surface of the center electrode 2.

In the second embodiment, the only difference from the first embodiment is based on a shape of the interior projection portion 41 of the housing 4. Thus, detailed discussion about the constituents of the spark plug 1 having the same function and the structure with those used in the first embodiment will be omitted.

As shown in FIG. 14, in the housing 4 according to the second embodiment has a triangular shaped interior projection portion 41 in the cross-sectional view.

In such the shape of the interior projection portions 41, only one edge portion is formed.

Such shaped interior projection portions 41 serve as the back electrodes which is one of members forming the hollow by which electric field originated from the center electrode 2 is concentrated near the first spark gap 11. The distribution of electric field generated by applying electric voltage to the center electrode 2 will be bounded by the pocket portion 13 so that electric field is concentrated near the first spark gap 11. Thus, the interior projection portions 41 leads to reduce the breakdown voltage in the capacitive discharge, and a required electric voltage which is required to be applied between the center electrode 2 and the ground electrode 6 of the spark plug 1 to induce the spark discharge is lowered so that ignitability and ignition performance of the spark plug 1 is improved.

Therefore, in the spark plug according to the modification of the first embodiment, the same advantages with the first embodiment can be obtained.

### Third Embodiment

Referring to FIG. 15, a third embodiment of the present invention will be explained.

FIG. 15 is an enlarged partial cross-sectional view showing an ignition portion of the spark plug 1 according to the third embodiment including the cylindrically shaped housing 4 provided with the interior projection portion 41, the cylindrically shaped insulator 3 attached to the housing 4, the elongated center electrode 2 inserted through the insulator 3 having the tip end face and the circumferential surface, the ground electrode 5 attached to the housing 4 and facing the tip end face of the center electrode 2, and the auxiliary ground electrode 6 whose tip end face faces the circumferential surface of the center electrode 2.

In the third embodiment, the only difference from the previous embodiments is based on a shape of the interior projection portion 41 of the housing 4. Thus, detailed discussion about the constituents of the spark plug 1 having the same function and the structure with those used in the first embodiment will be omitted.

As shown in FIG. 15, in the housing 4 according to the second embodiment has a semi-circular shaped interior projection portion 41 in the cross-sectional view.

In such shape of the interior projection portions 41, no edge portion is formed.

Such the shaped interior projection portions 41 serve as the back electrodes which are members forming the hollow by which electric field originated from the center electrode 2 is concentrated near the first spark gap 11. The distribution of electric field generated by applying electric voltage to the center electrode 2 will be bounded by the pocket portion 13 so that electric field is concentrated near the first spark gap 11. Thus, the interior projection portions 41 leads to reduce the breakdown voltage in the capacitive discharge, and a required electric voltage which is required to be applied between the center electrode 2 and the ground electrode 6 of the spark plug 1 to induce the spark discharge is lowered so that ignitability and ignition performance of the spark plug 1 is improved.

Therefore, in the spark plug according to the modification of the previous embodiments, the same advantages with the first embodiment can be obtained.

### Fourth Embodiment

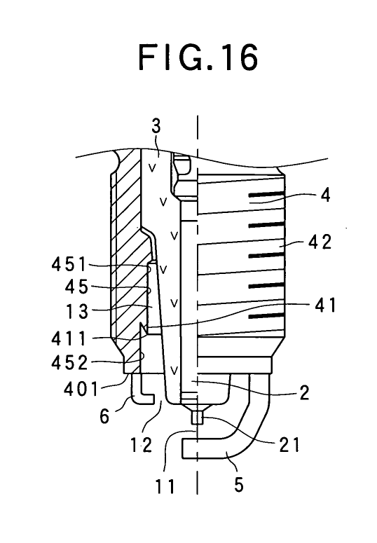

Referring to FIG. 16, a fourth embodiment of the present invention will be explained.

FIG. 16 is an enlarged partial cross-sectional view showing an ignition portion of the spark plug 1 according to the fourth embodiment including the cylindrically shaped housing 4 provided with the interior projection portion 41, the cylindrically shaped insulator 3 attached to the housing 4, the elongated center electrode 2 inserted through the insulator 3 having the tip end face and the circumferential surface, the ground electrode 5 attached to the housing 4 and facing the tip end face of the center electrode 2, and the auxiliary ground electrode 6 whose tip end face facing the circumferential surface of the center electrode 2.

In the fourth embodiment, the only difference from the previous embodiments is based on a shape of the interior projection portion 41 of the housing 4. Thus, detailed discussion about the constituents of the spark plug 1 having the same function and the structure with those used in the first embodiment will be omitted.

The small diameter portion of the housing 4 according to the present embodiment further has a first interior peripheral surface 451 and a second interior peripheral surface 452. Plane views of the first interior peripheral surface 451 and the second interior peripheral surface 452 are both circular shaped, and the first interior peripheral surface 451 and the second interior peripheral surface 452 are concentrically formed. The first interior peripheral surface 451 is positioned on the far side to the first end 401 of the housing 4, and the second interior peripheral surface 452 is positioned on the near side to the first end 401 of the housing 4. One end of the first interior peripheral surface 451 positioned on the near side to the first end 401 is closer to the first end 401 of the housing 4 than the end of the second interior peripheral surface 452 which is on the far side to the first end 401. Between the end of the first interior peripheral surface 451 and the one end of the second interior peripheral surface 452 on the far side to the first end 401, the interior projection portion 41 is formed to have one edge portion 411. The interior projection portion 41 is in the shape of a right-triangle in a cross sectional plane of the spark plug 1 containing the axis α thereof. One of the vertex of the right-triangle is positioned at the end of the first interior peripheral surface 451.

Such shaped interior projection portions 41 serve as the back electrodes which is one of the members forming the hollow by which electric field originated from the center electrode 2 is concentrated near the first spark gap 11. The distribution of electric field generated by applying electric voltage to the center electrode 2 will be bounded by the pocket portion 13 so that electric field is concentrated near the first spark gap 11. Thus, the interior projection portions 41 leads to reduce the breakdown voltage in the capacitive discharge, and a required electric voltage which is required to be applied between the center electrode 2 and the ground electrode 6 of the spark plug 1 to induce the spark discharge is lowered so that ignitability and ignition performance of the spark plug 1 is improved.

Therefore, in the spark plug according to the modification of the first embodiment, the same advantages with the previous embodiments can be obtained.

Further, it is allowed that the shape of the interior projection portion 41 in the cross sectional plane of the spark plug 1 containing the axis α thereof is not limited to the right triangle. Other shapes, such as hemicircle, semiellipse, and the like, can be allowed.

### Modification of the Embodiments

While the present invention has been disclosed in terms of the preferred embodiment in order to facilitate a better understanding thereof, it should be appreciated that the invention can be embodied in various ways without departing from the principle of the invention.

For example, the housings 4 according to the second and third embodiments have a plurality of the injection projection portions 41, as shown the plane view in FIG. 13 showing the spark plug taken along a line A-A of FIG. 2. In this case, the housings 4 have four injection projection portions 41, and each of the interior projection portions 41 is arranged in a position off by 90 degree from each other. Further number of the interior projection portions 41 should not be limited to four, and other numbers are allowed.

What is claimed is:

1. A spark plug having a longitudinal axis, comprising:
a center electrode that has a longitudinal axis aligned with the longitudinal axis of the spark plug and has an end thereof;
an insulator that has a first end and a second end opposite to the first end thereof along the longitudinal axis and holds the center electrode in a state where the end of the center electrode is protruded from the first end of the insulator;
a housing that has a first end and a second end opposite to the first end of the housing along the longitudinal axis of the spark plug, the first end of the housing being nearer to the first end of the insulator than the second end of the housing, and has a though-hole which is formed in the housing along the longitudinal axis of the spark plug and has an opening at the first end of the insulator, an inner peripheral surface of the housing defined by the through-hole having an insulator-holding portion where the insulator is held such that the first insulator end protrudes from the first housing end and an hollow portion so that an air pocket is formed between the inner peripheral surface of the hollow portion of the housing and an outer peripheral surface of the insulator;
a ground electrode that has a first end facing the end of the center electrode to form a first discharge gap at which spark discharge is ignited and a second end joined to the first housing end; an auxiliary ground electrode that has a first end facing of the first end of the insulator to form a second discharge gap and a second end joined to the first housing; and
a projected portion that is formed on the hollow portion of the inner peripheral surface of the housing and is projected from the inner peripheral surface of the hollow portion of the housing.

2. The spark plug according to claim 1, wherein
the projected portion formed on the hollow portion of the inner peripheral surface of the housing has an edge at which a diameter of the through-hole is suddenly changed.

3. The spark plug according to claim 1, wherein
when a first length which is a minimum length between the inner peripheral surface of the projected portion of the housing and the outer peripheral surface of the insulator and a second length of the first discharge gap formed between the end of the center electrode and the first end of the ground electrode, the first length is shorter than the second length.

4. The spark plug according to claim 1, wherein
the hollow portion of the through-hole of the housing has a first end on a far side of the first end of the housing and a second end at which the opening of the housing is formed, and
the projected portion is formed between the first end of the hollow portion and the second end of the hollow portion of the housing.

5. The spark plug according to claim 3, wherein
the hollow portion of the through-hole of the housing has a first end on a far side of the first end of the housing and a second end at which the opening of the housing is formed, and
the projected portion is formed between the first end of the hollow portion and the second end of the hollow portion of the housing.

6. The spark plug according to claim 4, wherein when a length of the hollow portion is defined as a length between the first end of the hollow portion and the second end of the hollow portion of the housing along the longitudinal axis of the center electrodes and a depth of the projected portion is defined as a minimum length between the first end of the hollow portion and the projected portion, the depth of the projection portion is larger than one third of the length of the hollow portion.
